(19) United States
(12) Patent Application Publication
(10) Pub. No.: US 2009/0281225 A1
(43) Pub. Date: Nov. 12, 2009

(54) EPOXY RESIN COMPOSITION FOR SEMICONDUCTOR ENCAPSULATION AND SEMICONDUCTOR DEVICE USING THE SAME

(75) Inventors: Takuya ETO, Ibaraki-shi (JP); Mitsuaki FUSUMADA, Ibaraki-shi (JP); Toshimichi SUZUKI, Ibaraki-shi (JP)

Correspondence Address: SUGHRUE-265550, 2100 PENNSYLVANIA AVE. NW, WASHINGTON, DC, 20037-3213, US

(73) Assignee: NITTO DENKO CORPORATION, Ibaraki-shi (JP)

(21) Appl. No.: 12/433,994

(22) Filed: May 1, 2009

(30) Foreign Application Priority Data
May 7, 2008 (JP) 2008-121554

(51) Int. Cl. C08K 3/22

(52) U.S. Cl. 524/437

(57) ABSTRACT

The present invention relates to an epoxy resin composition for semiconductor encapsulation, the epoxy resin composition including the following ingredients (A) to (C) and further including the following ingredient (D) as a flame retardant: (A) an epoxy resin; (B) a phenolic resin; (C) an inorganic filler; and (D) an aluminum hydroxide powder having a 50% volume cumulative diameter D₅₀ (μm) of 1.5 to 5 μm and a BET specific surface area S (m²/g) of 3.3/D₅₀≦S≦4.2/D₅₀, and having a ratio D₅₀/D₁₀ of 1.5 to 4 wherein D₁₀ is a 10% volume cumulative diameter thereof.

### FIELD OF THE INVENTION

The present invention relates to an epoxy resin-based resin composition for semiconductor encapsulation and a semiconductor device using the same.

### BACKGROUND OF THE INVENTION

Heretofore, semiconductor elements such as transistor, IC, LSI and the like are encapsulated with an epoxy resin composition to be in products of electronic components. Conventionally, as a flame retardant for enhancing the flame retardancy of the composition, a combination of a halogenated epoxy resin and antimony trioxide; a nitrogen-containing compound such as melamine; a phosphorus-containing compound such as phosphate; a metal hydroxide or the like is contained in the epoxy resin composition for semiconductor encapsulation. Recently, however, with the increase in the interest in the environmental problems, a method has been desired for imparting flame retardancy with no use of an environment-polluting substance such as halogen, antimony, etc.

For the above-mentioned requirements, use of a metal hydroxide such as aluminum hydroxide for imparting flame retardancy is under investigation. The metal hydroxide releases water through combustion (dehydration) and absorbs heat, thereby expressing an effect of flame retardation (see JP-A 2002-187999).

However, when the metal hydroxide is used in a resin for semiconductor encapsulation in the manner as above, many of the metal hydroxides may react with heat in the solder reflow process for semiconductor devices, to thereby release water. As a result, a problem that the cured resin composition for the semiconductor encapsulating is readily delaminated from lead frames may occur.

On the other hand, the resin composition for semiconductor encapsulating disclosed in JP-A 2002-187999 has excellent flowability. Additionally, since the aluminum hydroxide powder in the composition has a small specific surface area, the amount of water to be released with the composition could be lower than that with other metal oxides heretofore used in the art. However, since the water release occurs at a low temperature, the composition is still problematic in that it may generate foams in solder reflow treatment with the composition. Further, there is still room for improvement of the resin composition for semiconductor encapsulating disclosed in the above-mentioned JP-A 2002-187999, in view of the flame retardancy, the adhesiveness, the moisture resistance, and the insulation reliability thereof.

### SUMMARY OF THE INVENTION

The present invention has been made in consideration of the current situation as above, and objects thereof are to provide an epoxy resin composition for semiconductor encapsulation excellent in flame retardancy, and further in adhesiveness, moisture resistance, insulation reliability and flowability, and to provide a semiconductor device using the epoxy resin composition for semiconductor encapsulation.

Namely, the present invention relates to the following items (1) to (8).

(1) An epoxy resin composition for semiconductor encapsulation, the epoxy resin composition including the following ingredients (A) to (C) and further including the following ingredient (D) as a flame retardant:
(A) an epoxy resin;
(B) a phenolic resin;
(C) an inorganic filler; and
(D) an aluminum hydroxide powder having a 50% volume cumulative diameter D₅₀ (μm) of 1.5 to 5 μm and a BET specific surface area S (m²/g) of 3.3/D_{50'<S≦}4.2/D₅₀, and having a ratio D₅₀/D₁₀ of 1.5 to 4 in which D₁₀ is a 10% volume cumulative diameter thereof.

(2) The epoxy resin composition according to (1), in which the (D) aluminum hydroxide powder has an endothermic starting temperature of 240° C. or more and an endothermic peak temperature of 280 to 310° C., as determined through differential scanning calorimetry (DSC) where 10 mg of the aluminum hydroxide powder is used as a sample and the heating rate is 10° C./min.

(3) The epoxy resin composition according to (1) or (2), in which the (D) aluminum hydroxide powder has an endothermic peak calorie of 2.5 to 3.5 W/mg, as determined through differential scanning calorimetry (DSC) where 10 mg of the aluminum hydroxide powder is used as a sample and the heating rate is 10° C./min.

(4) The epoxy resin composition according to any one of (1) to (3), in which the (C) inorganic filler and the (D) aluminum hydroxide powder are contained in a total amount of 70 to 90% by weight based on a total amount of the epoxy resin composition.

(5) The epoxy resin composition according to any one of (1) to (4), in which the (D) aluminum hydroxide powder is contained in an amount of 3 to 40% by weight based on a total amount of the epoxy resin composition.

(6) The epoxy resin composition according to any one of (1) to (4), in which the (D) aluminum hydroxide powder is contained in an amount of 5 to 50% by weight based on a total amount of the (C) inorganic filler and the (D) aluminum hydroxide powder.

(7) The epoxy resin composition according to any one of (1) to (6), which further includes an acidic release agent.

(8) A semiconductor device obtained by resin-encapsulating a semiconductor element with the epoxy resin composition according to any one of (1) to (7).

Specifically, the present inventors have assiduously studied for the purpose of solving the above-mentioned problems. In the course of their studies, the inventors have reached a finding that the temperature at which aluminum hydroxide releases water tends to rise with the increase in the particle size of the compound, and on the contrary, when the compound of aluminum hydroxide contains a lot of fine powder, the water-releasing temperature thereof tends to lower. In addition, they have reached the conclusion that, when the particle size distribution width of the compound is narrowed, water release from the compound at a low temperature can be suppressed, and that, since the compound drastically begins to release water at a certain temperature, it is effective for fire extinguishing and for prevention of fire spreading with materials that are easy to burn. Given that situation, the inventors have studied aluminum hydroxide having an especially preferred particle size for an encapsulation material. As a result, they have found that, when an aluminum hydroxide powder having a narrow particle size distribution to fall within a specific particle size distribution range, like the above-mentioned ingredient (D), is used in resin, a resin composition excellent in flowability, flame retardancy, insulation reliability and moisture resistance, and further in adhesiveness can be obtained, thereby having completed the present invention.

As mentioned above, aluminum hydroxide has heretofore been used as a flame retardant. However, the aluminum hydroxide powder heretofore used in the art is generally one prepared by grinding aluminum hydroxide particles having a size of about 50 to 150 μm with a grinder such as a ball mill to those having a primary particle size or so, and their surfaces are suitably dissolved with sodium aluminate for making them into spherical particles. In the grinding process, the particle size distribution of the formed particles is broadened. The aluminum hydroxide powder actually used in the resin composition for semiconductor encapsulation disclosed in the above-mentioned JP-A 2002-187999 has an average particle size of about 5 μm, and has a specific surface area of 1.0 m²/g, and its product with the average particle size thereof is 4.4. Further, since the cumulative percentage by weight of the particles having a size of 1 μm or less is more than 20 %, D₅₀/D₁₀ of the powder is at least 5. Since such aluminum hydroxide powder is used, there may be a high possibility that water is released at lower temperature and the composition foams in solder reflow treatment. Further, large particles having a particle size of at least 10 μm, or that is, two times the particle size of the cumulative center particle size (D₅₀) of the aluminum hydroxide powder account for at least 8% by weight of the powder. Therefore, it may be considered that the adhesiveness and the insulation reliability of the resin composition may be poor. The aluminum hydroxide powder for use in the present invention differs from the conventional one mentioned in the above in view of the particle size distribution thereof. The powder in the invention is one specifically processed to have a unified particle size distribution. Accordingly, the dehydration starting temperature (endothermic starting temperature) of the aluminum hydroxide powder is high, and the epoxy resin composition for semiconductor encapsulation including such aluminum hydroxide powder can be remarkably improved in view of the necessary flowability, flame retardancy, moisture retardancy and adhesiveness, over conventional ones.

As in the above, since the epoxy resin composition for semiconductor encapsulation of the invention includes an aluminum hydroxide powder having a specifically-defined particle size, a specifically-defined specific surface area, and a specifically-defined particle size distribution, flowability thereof is excellent; and in solder reflowing, the composition is free from a trouble of delaminating owing to water release. Accordingly, the epoxy resin composition for semiconductor encapsulation of the invention is excellent in insulation reliability and flame retardancy.

In particular, when the aluminum hydroxide powder has an endothermic starting temperature of 240° C. or more and an endothermic peak temperature of 280 to 310° C., as determined through differential scanning calorimetry (DSC) where the weight of the sample is 10 mg and the heating rate is 10° C./min, the resin composition including the aluminum hydroxide powder may favorably encapsulate semiconductor elements not causing any failures of foaming and the like during molding.

In addition, when the aluminum hydroxide powder has an endothermic peak calorie of 2.5 to 3.5 W/mg, as determined through differential scanning calorimetry (DSC) where the weight of the sample is 10 mg and the heating rate is 10° C./min, the resin composition can attain fire extinguishing owing to cooling effect thereof, and can therefore prevent fire spreading, and the resin composition may have good flame retardancy. However, when the endothermic peak calorie is too large, the composition may lose flame-retardant capability thereof within a short period of time, and therefore the composition may fire away when exposed to flames for a long stretch of times.

### DETAILED DESCRIPTION OF THE INVENTION

Embodiments of the invention are described in detail bellow.

The epoxy resin composition for semiconductor encapsulation of the invention includes an epoxy resin (ingredient A), a phenolic resin (ingredient B), an inorganic filler (ingredient C), and a specific aluminum hydroxide powder (ingredient D), and is used generally in the form of a powder or in the form of tablets produced by tabletting the composition. As the case may be, the resin composition may be a granular encapsulating material produced by melt-kneading the composition followed by shaping it into nearly columnar granules or the like, or may be a sheet-like encapsulating material produced by shaping the melted composition into sheets.

The epoxy resin (ingredient A) is not particularly limited, but various epoxy resins such as dicyclopentadiene-type, cresol-novolak-type, phenol-novolak-type, bisphenol-type or biphenyl-type epoxy resins may be used. These epoxy resins may be used alone or in combination thereof.

The (A) epoxy resin is preferably one having an epoxy equivalent of 185 to 205, more preferably 190 to 200, from the viewpoint of the moldability thereof. Specifically, when the epoxy equivalent thereof is less than 185, the resin may have poor flowability. On the other hand, when the epoxy equivalent thereof is more than 205, the resin may have a problem in the curability thereof.

In case where the ingredient (A) is a cresol-novolak-type epoxy resin, one having a softening point of 50 to 80° C. is preferably used in view of the handlability and the moldability of the resin. Further, one having a softening point of 55 to 75° C. is more preferably used. When the softening point thereof is lower than 50° C., the resin composition, especially its powders may often be adhered each other. On the other hand, when the softening point thereof is higher than 80° C., the resin composition may have a problem in the flowability thereof.

The phenolic resin (ingredient B) to be used along with the epoxy resin (ingredient A) acts as a curing agent for the epoxy resin, and is not particularly limited. Examples of the ingredient (B) include a dicyclopentadiene-type phenolic resin, a phenol-novolak resin, a cresol-novolak resin, a phenol-aralkyl resin. These phenolic resins may be used alone or in combination thereof. Of these, the phenolic resin having a hydroxyl equivalent of 70 to 250 and a softening point of 50 to 110° C. is preferably used. Incidentally, the phenol-novolak resin is produced by reacting a phenolic hydroxyl group-having compound such as phenol or naphthol with an aldehyde, a ketone or the like in an acidic atmosphere. In a broad sense of the word, the resin includes a phenol-aralkyl resin to be produced through reaction of a phenolic compound and an aromatic compound having a methoxymethylene group or the like.

The blend ratio of the epoxy resin (ingredient A) and the phenolic resin (ingredient B) is preferably selected so that the hydroxyl group in the phenolic resin may be 0.7 to 1.3 equivalents, more preferably 0.9 to 1.1 equivalents, relative to 1 equivalent of the epoxy group in the epoxy resin.

The inorganic filler (ingredient C) used in the invention is not particularly limited, and may be used any known one. Examples thereof include silica powder, alumina powder, quartz glass powder, talc, aluminum nitride powder, silicon nitride powder. These inorganic filler may be used alone or in combination thereof. For use where high thermal conductivity is needed, alumina powder and silica powder are preferred, and in particular, ground powder of crystalline silica (hereinafter referred to as “ground crystalline silica powder”) is more preferred. However, in case where the inorganic powder is additionally required to have a flame retardation effect, use of crystalline silica having a high thermal conductivity is disadvantageous. It is preferred that the ground crystalline silica powder is further processed for abrasion to round the corner edges of the particles for enhancing the flowability of the resin composition containing the powder. On the other hand, when the linear expansion coefficient of the resin composition is desired to be lowered, an amorphous silica powder prepared by melting the crystalline powder (hereinafter referred to as “molten silica powder”) is preferably used in the composition. It is preferred that the molten silica powder is one prepared by spraying a ground crystalline or amorphous silica powder into a flame and melting the particles into spherical ones, for further enhancing the flowability of the resin composition including the powder.

The average particle size of the (C) inorganic filler is preferably 5 to 30 μm, more preferably 5 to 25 μm. Specifically, when the average particle size thereof is less than 5 μm, the flowability of the resin composition may be poor. On the other hand, when the average particle size is more than 30 μm, the large particles may cause a trouble of clogging in a mold gate. Further, the maximum particle size thereof is preferably 64 μm or less for small-sized semiconductor packages, as the molding appearance is excellent and smooth. The case is especially preferred, as not causing troubles of flow failure owing to the inorganic filler being caught by the gate, and troubles of wire deformation and void formation in wires owing to the inorganic filler being sandwiched between wires. The average particle size can be measured, for example, using a laser diffraction/scattering particle size distribution analyzer.

The aluminum hydroxide powder (ingredient D) to be used in the composition along with the above-mentioned ingredients (A) to (C) has a 50% volume cumulative diameter D₅₀ (μm) of 1.5 to 5 μm and a BET specific surface area S (m²/g) of 3.3/D₅₀≦S≦4.2/D₅₀, and having a ratio D₅₀/D₁₀ of 1.5 to 4 in which D₁₀ is the 10% volume cumulative diameter thereof. The 50% volume cumulative diameter (average particle size) D₅₀ (μm) of the aluminum hydroxide powder corresponds to 50% of the data accumulated from smaller particles in determination with a laser particle size distribution analyzer. Similarly, the 10% volume cumulative diameter D₁₀ of the powder corresponds to 10% of the data accumulated from smaller particles in determination with a laser particle size distribution analyzer.

For expressing the width of the particle size distribution of the aluminum hydroxide powder, the ratio to the particle size in 10% accumulation is taken, as in the above. When the value is large, the distribution width is broad. On the other hand, when the value is small, the width is narrow. In the invention, the ratio of D₅₀ to the 10% volume cumulative diameter D₁₀, D₅₀/D₁₀, is defined to be 1.5 to 4, as in the above. Namely, when the value of D₅₀/D₁₀ falls within the above-mentioned range, the composition has excellent flowability. When the value is nearer to 1, the particles are monodispersed. However, the value of 1.5 is a realistic limit as in the above. Further, when the value is more than 4, the particles contain much fine powder and the endothermic starting temperature (dehydration starting temperature) thereof tends to be lower.

On the other hand, when the particle size of the aluminum hydroxide powder is large, the dehydration temperature thereof may be high. In this case, however, the powder may often have structural defects and the mechanical properties of the cured product of the resin composition may worsen. In addition, the composition may form bubbles or may release ionic impurities. Further, when the particle size of the powder is large, the powder may be insufficiently washed with water to remove sodium. In this case, the remaining sodium or the like may have a dehydration catalytic effect and may lower the dehydration starting temperature of the powder. Further, when large particles or massive crystals are prepared and thereafter they are mechanically ground into small particles having a reduced particle size, the resulting particles may have a complicated particle shape and may contain much fine powder having a large specific surface area. In addition, owing to the fine cracks formed in the mechanically-ground particles, bubbles may be taken into the resin composition, and therefore the mechanical strength of the composition may be deteriorated. For solving these problems, the aluminum hydroxide powder (ingredient D) is specifically so defined as to have a 50% volume cumulative diameter D₅₀ (μm) of 1.5 to 5 μm and to have a BET specific surface area S (m²/g) satisfying 3.3/D₅₀≦S≦4.2/D₅₀.

For obtaining the aluminum hydroxide powder having a uniform particle size as above, for example, a method of producing aluminum hydroxide according to a Bayer process under the condition of unifying the primary particle size of the particles to be obtained; a method including removal of fine powder as a supernatant from a secondary particle dispersion followed by removal of crude powder through particle precipitation or net filtration to thereby unify the particle size of the particles to be obtained; a method of removal of crude powder and fine powder after processing of sodium aluminate in a slurry state according to the above-mentioned method; or a method of pneumatic classification of dry powder to unify the particle size of the particles to be obtained, may be mentioned.

The BET specific surface area of the aluminum hydroxide powder may be determined with a BET specific surface area measuring device where nitrogen is used as an adsorbent. The BET specific surface area is a specific surface area per unit weight, and when a particle is presumed to be a true sphere, the specific surface area S (m²/g) and the diameter R (μm) thereof satisfies the following numerical formula (1):

S=πR²/(d·(πR³/6))=6/d·R (1)

in which π means the ratio of the circumference of a circle to its diameter, and d is the specific gravity of the particle (g/cm³).

Accordingly, the specific gravity of the particle in this case can be calculated according to the following numerical formula (2):

d=6/(S·R) (2).

Since the specific gravity (true specific gravity) of a single crystal of aluminum hydroxide is 2.42, when the particle is assumed as the true sphere, the true sphere of the aluminum hydroxide particle has the value S·R of 2.5. On the other hand, when the particle is deviated from a true sphere, the estimated specific gravity of the particle lowers upon the above formula using the measured specific surface area as S and the measured average particle size (D₅₀) as R. Aluminum hydroxide powder having an such estimated specific gravity of 75% or less of the true specific gravity is preferred. Since the aluminum hydroxide powder has an estimated specific gravity smaller than that of the true sphere, or that is, the specific surface area thereof is larger than that of the true sphere, the flame-retarding effect of the powder is high. On the other hand, it is preferred that the estimated specific gravity of the powder is 60% or more of that of the true sphere, from the viewpoint of preventing viscosity increase and preventing release of ionic impurities. In case where the estimated specific gravity is 75% or less of the true gravity, S·D₅₀ is 3.3 or more; and when the estimated specific gravity is about 60% or more, S·D₅₀ is 4.2 or less.

The aluminum hydroxide powder such as that mentioned in the above can be prepared preferably according to the production method disclosed in JP-A 2003-95645. Specifically, according to the production method, secondary particles of aluminum hydroxide are dissolved, thereby obtaining stable and nearly spherical primary particles of aluminum hydroxide. According to the production method, since an aluminum hydroxide powder of particles having a small surface area and having few cracks can be obtained, sodium is prevented from being taken into the particles, and the aluminum hydroxide powder having the sodium content of 0.1% or less by weight as calculated in terms of Na₂O can be obtained. Sodium has an effect of promoting release of water from aluminum hydroxide, and it can be said that the aluminum hydroxide powder thus having a reduced sodium content may have excellent heat resistance.

The heat resistance of the (D) aluminum hydroxide can be confirmed through differential scanning calorimetry (DSC). Specifically, 10 mg of a sample of aluminum hydroxide is taken, set in a DSC device and heated at a heating rate of 10° C./min to determine the endothermic/exothermic heat amount. During water release, the system is endothermic, and the endothermic starting temperature and the amount of heat at the endothermic peak temperature are determined.

In determination through DSC mentioned in the above, the endothermic starting temperature is preferably 240° C. or more and the endothermic peak temperature is preferably 280 to 310° C. Specifically, when the endothermic starting temperature is lower than the range, water may be released from aluminum hydroxide during molding or during post-curing, therefore generation of bubbles and other failures may occur. Further, when the endothermic peak temperature is lower than 280° C., water release may be great during moisture-absorbing solder reflow treatment at a high temperature such as 260° C., therefore causing a trouble of resin delaminating from the constitutive components, lead frames or substrates, and a trouble of resin cracking.

In the above DSC, the endothermic peak calorie of the sample is preferably 2.5 to 3.5 W/mg for effective flame retardancy.

For the endothermic starting temperature in DSC, the rising temperature to give the endothermic peak is confirmed, however, there may appear some minor peaks or lump-like swellings before the main endothermic peak. In such a case, when the endothermic level on the high-temperature side of the minor peaks or swellings is 5% or less of the endothermic peak level, these minor peaks or swellings may be ignored, and the temperature corresponding to the rising part of the endothermic peak is determined.

Even when the endothermic starting temperature is lower than the solder reflow temperature, the resin does not delaminate owing to water diffusion so far as the endothermic peak temperature falls within the above-mentioned range. When the endothermic heat at 250° C. or lower is 5% or less of the endothermic peak in DSC, there may not occur any serious problem in the solder reflowability of the resin composition at 260° C.

In the epoxy resin composition for semiconductor encapsulation of the invention, since the (D) aluminum hydroxide powder has a specific particle size, a specific surface area and a specific particle size distribution width as described above, the resin composition has excellent adhesiveness to constitutive components, lead frames and substrates. Since fine powder may bring about viscosity increase or may cause formation of bubbles in interfaces, the adhesiveness of the resin composition is lowered. However, in the invention, since the particle size distribution width of the powder is narrow, the resin composition hardly brings about such failures. In addition, aluminum hydroxide is low in strength as compared with an inorganic filler such as silica, and when the aluminum hydroxide powder contains large particles, there may occur cracks starting from the large particles. Further, the large particles may be starting points of interfacial delaminating as their cohesive force is low. However, the invention is free from such failures. In addition, since the (D) aluminum hydroxide powder releases water drastically at a certain temperature, it is effective for fire extinguishing and for preventing fire spreading even for those that are easy to burn. Accordingly, the amount of aluminum hydroxide to be added to the resin composition of the invention may be reduced, and this is favorable for reducing ionic impurities.

Aluminum hydroxide is amphoteric and is readily corroded by acid/base. However, since the (D) aluminum hydroxide has a specific surface area, therefore it is free from such problem.

For further enhancing the heat resistance of aluminum hydroxide, it may be processed for hydrothermal treatment.

In the epoxy resin composition for semiconductor encapsulation of the invention, the (C) inorganic filler and the (D) aluminum hydroxide powder is preferably contained in an amount of 70 to 90% by weight based on the total amount of the epoxy resin composition, from the viewpoint of the properties of the cured product and the flowability of the resin composition during molding.

Also, the (D) aluminum hydroxide powder is preferably contained in an amount of 3 to 40% by weight based on the total amount of the epoxy resin composition, from the viewpoint of the flame-retardant effect of the cured product and the reduction in ionic impurities in the product.

Further, the (D) aluminum hydroxide powder is preferably contained in an amount of 5 to 50% by weight based on the total amount of the (C) inorganic filler and the (D) aluminum hydroxide powder, from the viewpoint of the flame-retardant effect of the cured product and the reduction in ionic impurities in the product.

Since aluminum hydroxide has ionic character, it may catch the curing accelerator that is a reaction catalyst of epoxy resin and phenolic resin, thereby lowering the curing reactivity of the resin composition. In such a case, a curing accelerator capable of forming a salt or an adduct with phenolic resin or epoxy resin may be used, so that the curing accelerator may be stabilized and hardly reacts with aluminum hydroxide, and the resin composition may have excellent curability.

When the epoxy resin and the phenol-novolak resin are used, they may react to cure, but the reaction rate is low. In such a case, an imidazole-type, amine-type or phosphorus-containing curing accelerator or the like may be preferably used along with the epoxy resin and the phenol-novolak resin. Specifically, since the imidazole-type or amine-type curing accelerator exhibits an excellent effect of curing promotion when used along with a metal hydroxide, it can be favorably used in the resin composition of the invention. In case where an electric reliability is predominantly taken into consideration for the product, a phosphorus-containing curing accelerator is preferred.

For enhancing the moldability of the resin composition, a latent curing accelerator which is capable of suppressing the viscosity elevation of the resin composition in a flow state but which reacts drastically at a time in curing may be used in the composition. Specifically, phosphine-quinone adducts, phosphine-phenol adducts and the like may be mentioned as such curing accelerator.

Further, the epoxy resin composition for semiconductor encapsulation of the invention preferably contains an acidic release agent along with the other constitutive ingredients for enhancing the dispersibility of aluminum hydroxide therein. The release agent includes, for example, those having a carboxyl group, etc.

Since aluminum hydroxide is hardly caught by the catalyst and the catalyst may exhibit a latent catalytic activity, the acidic release agent is preferably previously reacted with a basic catalyst. By previously forming a salt with the release agent as described above, the resin curability on the mold surface is enhanced and the molded article can be readily released from the mold.

In addition to the above, a silane coupling agent, a pigment, a flame retardant, a flame retardation aid, a release agent or the like may be further added to the epoxy resin composition for semiconductor encapsulation of the invention.

The silane coupling agent is preferably one having a functional group capable of reacting with epoxy resin and/or phenol-novolak resin and an alkoxysilane skeleton. Examples thereof include γ-mercaptopropyltrimethoxysilane, γ-aminopropyltrimethoxysilane, γ-aminopropyltrimethoxysilane, γ-glycidoxypropyltrimethoxysilane.

As the pigment, carbon black having a discharging effect may be used.

As the flame retardant other than aluminum hydroxide, bromine-containing flame retardants, nitrogen-containing flame retardants, phosphorus-containing flame retardants, metal hydroxides except for aluminum hydroxide, metal hydrates and the like may be mentioned. Any of these may be used in the resin composition along with aluminum hydroxide.

Metal hydroxides and metal hydrates have excellent flame retardancy, but they often worsen waterproofness. However, in case where an alkoxy group-having silicone resin compound is used in the resin composition, it may have a protective effect and the waterproofness of the resin composition is not almost worsened. Therefore, combined use of the two is preferred.

Examples of the flame retardation aid include antimony trioxide. When combined with a bromine-containing compound, it exhibits an excellent flame retardation effect. However, these have toxic ingredients such as bromine and antimony, and flame retardants not containing them are preferred.

The release agent is preferably an acidic one as described above, however, use of any other release agent is not denied herein. For example, camauba wax, paraffin wax, polyethylene wax, montanic acid wax, nonionic surfactant-like paraffin, and wax having a polyethylene chain and an alkylene glycol chain may be used as the release agent.

For solving the problem of metal corrosion (corrosion of semiconductor elements, aluminum wires) by ionic impurities, an ion-exchange material such as an inorganic hydrotalcite-like compound or bismuth compound may be added to the resin composition, and the semiconductor elements and the like encapsulated with the resin composition may have a prolonged life.

The epoxy resin composition for semiconductor encapsulation of the invention can be produced, for example, as follows. Specifically, an epoxy resin (ingredient A), a phenolic resin (ingredient B), an inorganic filler (ingredient C), a specific aluminum hydroxide powder (ingredient D) and other optional additives are blended in a predetermined ratio, and then fully mixed in a mixer, etc. Subsequently, the mixture thereof is melt-kneaded under heat by using a mixing roll, a kneader or the like kneading machine, followed by cooling to room temperature. Then, this is ground and optionally tabletted. Through the process including the series of such steps, the intended epoxy resin composition for semiconductor encapsulation can be produced.

Alternatively, a mixture of the epoxy resin composition for semiconductor encapsulation is introduced into a kneading machine, then kneaded therein in melt, and thereafter continuously molded into nearly columnar granules or pellets. According to the process including the series of such steps, the intended epoxy resin composition for semiconductor encapsulation can also be produced.

Further, a mixture the epoxy resin composition for semiconductor encapsulation is received on a palette, cooled thereon, and pressed or rolled, or a mixture of the composition with a solvent is applied onto a substrate to form a sheet thereon. According to such steps, a sheet-like epoxy resin composition for semiconductor encapsulation can be produced.

A method of encapsulating a semiconductor element with the thus-obtained epoxy resin composition for semiconductor encapsulation (powdery, tablet-like, granular, etc.) is not particularly limited, and any known molding method such as transfer molding, etc may be used.

Using the sheet-like epoxy resin composition for semiconductor encapsulation, a semiconductor device can be produced, for example, according to flip-chip packaging as follows. Briefly, the sheet-like epoxy resin composition for semiconductor encapsulation is applied to the side of an electrode of a semiconductor element provided with a bonding bump, or is disposed on the bump-bonding side of a circuit board, and the semiconductor element and the circuit board are bump-bonded to each other and are simultaneously resin-encapsulated together for flip-chip packaging to construct a semiconductor device.

### EXAMPLES

The invention is described with reference to the following Examples and Comparative Examples. However, the invention should not be limited to these examples. The blended ratio is in terms of part by weight.

The following materials were prepared.

Epoxy Resin: O-cresol-novolak epoxy resin (epoxy equivalent: 200, softening point: 70° C.).

Phenolic Resin: Phenol-formaldehyde-novolak resin (hydroxyl equivalent: 1.05, softening point: 71° C.).

Curing accelerator: 1,8-Diazabicyclo(5.4.0)undecene-7.

Inorganic Filler a: Molten and ground silica (average particle size: 6 μm, maximum particle size: 48 μm).

Inorganic Filler b: Molten spherical silica powder (average particle size: 14 μm, maximum particle size: 64 μm).

Aluminum Hydroxides A to E:

Aluminum hydroxides each having a particle size distribution (measured with a laser particle size distribution analyzer: 50% volume cumulative diameter D₅₀ (μm), 10% volume cumulative diameter D₁₀ (μm), D₅₀/D₁₀, 3.3/D₅₀, 4.2/D₅₀), a BET specific surface area S (m²/g) (measured with a BET specific surface area measuring device), an endothermic starting temperature (° C.), an endothermic peak temperature (° C.), and an endothermic peak calorie (W/mg) (measured through DSC where the sample weight is 10 mg and the heating speed is 10° C./min).

TABLE 1

| | Aluminum Hydroxide | | | | |
|---|---|---|---|---|---|
| | A | B | C | D | E |
| 50% volume cumulative | 1.5 | 3.0 | 5.0 | 12 | 1.0 |
| diameter D₅₀ (μm) | | | | | |
| 10% volume cumulative | 0.8 | 1.1 | 1.3 | 1.9 | 0.7 |
| diameter D₁₀ (μm) | | | | | |
| D₅₀/D₁₀ | 1.88 | 2.73 | 3.85 | 6.32 | 1.43 |
| 3.3/D₅₀ | 2.2 | 1.1 | 0.66 | 0.28 | 3.3 |
| 4.2/D₅₀ | 2.8 | 1.4 | 0.84 | 0.35 | 4.2 |
| BET Specific Surface | 2.7 | 1.4 | 0.8 | 1.2 | 3.2 |
| Area S (m²/g) | | | | | |
| Endothermic Starting | 240 | 255 | 260 | 260 | 210 |
| Temperature (° C.) | | | | | |
| Endothermic Peak | 285 | 290 | 305 | 300 | 276 |
| Temperature (° C.) | | | | | |
| Endothermic Peak | 3.0 | 3.2 | 2.7 | 2.0 | 2.8 |
| Calorie (W/mg) | | | | | |

Pigment: Carbon Black

Silane Coupling Agent: y-mercaptopropyltrimethoxysilane.

Release Agent: Polyethylene oxide wax (acid value; 60, weight-average molecular weight: 4000).

### Examples 1 to 3, Comparative Examples 1 to 3

The above-described materials were mixed at room temperature in a ratio shown in Table 2 below, and then processed in a roll kneader heated at 80 to 120° C. in which the resin was melt-kneaded (for 5 minutes) to prepare an epoxy resin composition where the inorganic filler and others were dispersed in the resin. Subsequently, the meltage was cooled and the resulting solid was ground into powder. The powder was put into a cylindrical mold, and pressure was given thereto from both ends thereby producing columnar tablets having a predetermined external form and a predetermined weight.

The resin composition tablets thus produced were evaluated for their properties according to the standards mentioned below, and the results are shown in Table 2 below.

Solder Resistance

Using the resin composition tablets produced in the above, a 80-pin QFP package was molded with a low-pressure transfer molding machine at a molding temperature of 175° C. and an injection pressure of 7 MPa and for a curing time of 120 seconds. Specifically, a copper lead frame having a die pad size of 8 mm square and a thickness of 0.15 mm was prepared; a silicon element having a size of 5.5 mm square and a thickness of 0.4 mm was adhered to the die pad with a die-attaching adhesive; the element electrode and the lead frame were electrically connected with each other via a gold wire; this was set in a predetermined position of a lower mold having a recessed cavity, then sandwiched between the lower mold and an upper mold also having a recessed cavity; the resin composition tablets prepared in the above were put into a resin pot; according to the above-mentioned condition, the resin composition as pressurized with a plunger was injected into the cavity formed between the upper and lower molds, and the resin was cured to produce a semiconductor device. The lead frame dam part was removed by die cutting, and individual semiconductor devices were produced as separate ones. These were tested for moisture absorption at a JEDEC humidity sensitivity level 3 (moisture absorption condition: 30° C.×60% RH×192 hours), and then exposed to a solder reflow thermal profile under a condition of 260° C. (peak)×30 seconds thereby confirming the presence or absence of lead frame delaminating in the tested samples. The samples with no lead frame delaminating are good (“A”); and those with some delaminating are not good (“B”).

Flame Retardancy

Using a low-pressure transfer molding machine, the resin composition tablets produced in the above were molded into test pieces having a thickness of 3.2 mm (127 mm×12.7 mm×3.2 mm) and test pieces having a thickness of 1.6 mm (127 mm×12.7 mm×1.6 mm), at a molding temperature of 175° C. and an injection pressure of 7 MPa for a curing time of 120 seconds. These were post-cured at 175° C. for 8 hours, then tested according to a UL-94 vertical process to determine the total combustion time and the longest combustion time. Based on the obtained data, the samples were investigated as to whether they could satisfy the V-0 standard. Those satisfying the standard are good (“A”), and those not satisfying it are not good (“B”).

Flowability

Using a spiral flow test mold according to Spiral Flow Specification (EMMI-1-66), the resin composition tablets produced in the above were tested for the flowability at a mold temperature of 175° C. and an injection pressure of 7 MPa for a curing time of 120 seconds. The samples having a flowability of more than 50 cm are good (“A”); and those having a flowability of at most 50 cm are not good (“B”).

Adhesiveness

Using a low-pressure transfer molding machine, the resin composition tablets produced in the above were molded into a circular truncated cone (upper diameter 3 mm, lower diameter 3.568 mm, height 3 mm, adhesion area 10±0.5 mm²) on an NiPdAu plated lead frame board, at a molding temperature of 175° C. and an injection pressure of 7 MPa and for a curing time of 120 seconds. Subsequently, this was removed from the low-pressure transfer molding machine, and post-cured at 175° C. for 5 hours. Using a universal testing machine, a flat plate was pushed to the side of the circular truncated cone (cured resin article) at a rate of 5 mm/minute, whereupon the maximum power with which the circular truncated cone delaminated from the board was measured. 10 test pieces of the same sample were tested, and the data were averaged. The samples having an average value of at least 9.8 MPa (1 kg/mm²) are good (“A”); and those having an average value of lower than 9.8 MPa (1 kg/mm²) are not good (“B”).

TABLE 2

| | | Example | | | Comparative Example | | |
|---|---|---|---|---|---|---|---|
| | | 1 | 2 | 3 | 1 | 2 | 3 |
| Epoxy Resin | | 15.5 | 15.5 | 15.5 | 15.5 | 15.5 | 15.5 |
| Phenolic Resin | | 8.2 | 8.2 | 8.2 | 8.2 | 8.2 | 8.2 |
| Curing accelerator | | 0.35 | 0.35 | 0.35 | 0.35 | 0.35 | 0.35 |
| Inorganic Filler a | | 88 | 80 | 48.6 | 80 | 80 | 80 |
| Inorganic Filler b | | 7.9 | 7.9 | 7.9 | 7.9 | 7.9 | 7.9 |
| Aluminum Hydroxide A | | 7.9 | — | — | — | — | — |
| Aluminum Hydroxide B | | — | 15.7 | — | — | — | — |
| Aluminum Hydroxide C | | — | — | 47.1 | — | — | — |
| Aluminum Hydroxide D | | — | — | — | 15.7 | — | — |
| Aluminum Hydroxide E | | — | — | — | — | 15.7 | — |
| Carbon Black | | 1.3 | 1.3 | 1.3 | 1.3 | 1.3 | 1.3 |
| Silane Coupling Agent | | 0.2 | 0.2 | 0.2 | 0.2 | 0.2 | 0.2 |
| Release Agent | | 1 | 1 | 1 | 1 | 1 | 1 |
| Solder Resistance | | A | A | A | A | B | A |
| Flame | 3.2 mm V-0 | A | A | A | A | B | B |
| Retardancy | 1.6 mm V-0 | A | A | A | B | B | B |

| | | | | | | |
|---|---|---|---|---|---|---|
| Flowability | A | A | A | A | B | A |
| Adhesiveness | A | A | A | B | B | A |

From the above results, it can be seen that all the samples of Examples are excellent in point of all the evaluations of the solder resistance, the flame retardancy, the flowability and the adhesiveness. As opposed to these, the sample of Comparative Example 1 containing aluminum hydroxide having a large average particle size (D₅₀) as a flame retardant was problematic in the flame retardancy in the 1.6 mm V-0 test; and on the other hand, the sample of Comparative Example 2 containing aluminum hydroxide having a small average particle size contrary to the above had poor flowability. It is observed that when the endothermic starting temperature of aluminum hydroxide is low, the flame retardancy thereof tends to be poor; and when the peak endothermic temperature of aluminum hydroxide is low, the flame retardancy thereof also tends to be poor.

While the invention has been described in detail and with reference to specific embodiments thereof, it will be apparent to one skilled in the art that various changes and modifications can be made therein without departing from the spirit and scope thereof.

This application is based on Japanese Patent Applications (Patent Application Nos. 2008-121554) filed on May 7, 2008, the entirety of which is incorporated herein by way of reference.

All references cited herein are incorporated by reference herein in their entirety.

What is claimed is:

1. An epoxy resin composition for semiconductor encapsulation, said epoxy resin composition comprising the following ingredients (A) to (C) and further comprising the following ingredient (D) as a flame retardant:
(A) an epoxy resin;
(B) a phenolic resin;
(C) an inorganic filler; and
(D) an aluminum hydroxide powder having a 50% volume cumulative diameter D₅₀ (μm) of 1.5 to 5 μm and a BET specific surface area S (m²/g) of 3.3/D₅₀≦S≦4.2/D₅₀, and having a ratio D₅₀/D₁₀ of 1.5 to 4 wherein D₁₀ is a 10% volume cumulative diameter thereof.

2. The epoxy resin composition according to claim 1, wherein the (D) aluminum hydroxide powder has an endothermic starting temperature of 240° C. or more and an endothermic peak temperature of 280 to 310° C., as determined through differential scanning calorimetry (DSC) where 10 mg of the aluminum hydroxide powder is used as a sample and the heating rate is 10° C./min.

3. The epoxy resin composition according to claim 1, wherein the (D) aluminum hydroxide powder has an endothermic peak calorie of 2.5 to 3.5 W/mg, as determined through differential scanning calorimetry (DSC) where 10 mg of the aluminum hydroxide powder is used as a sample and the heating rate is 10° C./min.

4. The epoxy resin composition according to claim 1, wherein the (C) inorganic filler and the (D) aluminum hydroxide powder are contained in a total amount of 70 to 90% by weight based on a total amount of the epoxy resin composition.

5. The epoxy resin composition according to claim 1, wherein the (D) aluminum hydroxide powder is contained in an amount of 3 to 40% by weight based on a total amount of the epoxy resin composition.

6. The epoxy resin composition according to claim 1, wherein the (D) aluminum hydroxide powder is contained in an amount of 5 to 50% by weight based on a total amount of the (C) inorganic filler and the (D) aluminum hydroxide powder.

7. The epoxy resin composition according to claim 1, which further comprises an acidic release agent.

8. A semiconductor device obtained by resin-encapsulating a semiconductor element with the epoxy resin composition according to claim 1.
